(19) United States
(12) Patent Application Publication
(10) Pub. No.: US 2002/0130645 A1
(43) Pub. Date: Sep. 19, 2002

(54) Overvoltage protection device for buck converter

(76) Inventors: Sheng-Nan Tsai, Taoyan (TW); Kuang-Hua Ou Yang, Jungli City (TW)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/021,672

(22) Filed: Dec. 12, 2001

(30) Foreign Application Priority Data
Mar. 15, 2001 (TW) 90106113

(51) Int. Cl. G05F 1/40

(52) U.S. Cl. 323/274

(57) ABSTRACT

An overvoltage protection device for use with a buck converter comprises a transistor switch coupled in series between an input voltage and a voltage switch of the buck converter for preventing the buck converter from outputting an excessive voltage as the voltage switch of the buck converter is short-circuited. A voltage detecting circuit is placed at the voltage output terminal of the buck converter for comparing the output voltage of the buck converter with a reference voltage to detect whether the output voltage exceeds a predetermined voltage level, and in response thereto, outputs a control signal to the PWM controller of the buck converter and the transistor switch. When the buck converter outputs an excessive voltage, the PWM controller is forced to shut down responsive to the control signal, and the transistor switch also turns off responsive to the control signal to cut off the energy of the buck converter.

### FIELD OF THE INVENTION

The present invention is related to a step-down converter (also referred to as a buck converter hereinafter) In particular, the present invention is related to an overvoltage protection device which can be biased to prevent the buck converter from suffering an output voltage beyond a predetermined voltage level, as a short-circuit failure of voltage switch for the buck converter.

### DESCRIPTION OF THE PRIOR ART

In the field of power supply design technology, the switching mode power supply (SMPS) is widely employed to the electronic product which is powered by battery cells, such as a laptop computer. The buck converter (or step-down converter) serves as a basic voltage regulator for a switching mode power supply. The buck converter is characterized by receiving a direct current (DC) voltage as an input DC voltage, for example, the DC voltage provided by a battery cell, and converting the input DC voltage into a lower output DC voltage to power a load. FIG. 1 shows a typical circuit block diagram of a buck converter. As can be seen from FIG. 1, the buck converter of the prior art in general comprises a pulse width modulator controller (PWM controller) 101, such as a 3843 or 3844 series integrated circuit chip, which acts as a power supply control circuit for the switching mode power supply. In order to normally initialize its control functions of the PWM controller 101, a startup circuit 100 is required to provide sufficient voltage and current to the PWM controller 101. The PWM controller 101 receives a first reference voltage V_{ref1} and compares the first reference voltage V_{ref1} with an output voltage Vₒᵤₜ of the buck converter (which is fed from the voltage output terminal of the buck converter back to the PWM controller 101 through a feedback circuit 108) to generate a switch control signal to drive the transistor switch 102 to convert the DC voltage, whereby maintaining a desired output voltage level. The transistor switch 102 is formed from a N-channel MOSFET with its gate connected to the PWM controller 101. The PWM controller 101 issues a switch control signal to turn the transistor switch 102 on and off. If the gate voltage of the transistor switch 102 exceeds its gate threshold voltage, the transistor switch 102 will be fully turned on and vice versa. The output voltage of the buck converter is provided by an output filter 104 comprising an inductor 1041 and a capacitor 1042 to power a load 107.

However, in actual operation, it is found that the buck converter may have chance to get short-circuited in virtue of some factors. If the transistor switch 102 is short-circuited failure, the voltage input terminal and the voltage output terminal of the buck converter will be fully conducted, and an excessive output voltage will be directly outputted from the voltage output terminal of the buck converter. As a result, the output voltage Vₒᵤₜ of the buck converter will be too high so that the electronic components on its output as the load could be burned out due to the overvoltage.

To avoid an excessive output voltage of the buck converter due to the short-circuited voltage switch of the buck converter, conventionally an overvoltage detecting circuit 106 is applied to trigger a silicon-controller rectifier (or SCR) 105 which is connected between the voltage output terminal of the buck converter and the overvoltage detecting circuit 106 to ground. Because the on-resistance of the SCR 105 being triggered on by the overvoltage detecting circuit 106 will be quite small, the SCR 105 is able to prevent the voltage output of the buck converter from rising. At the same time, a fuse 109 which is connected between the input voltage Vᵢₙ and the transistor switch 102 is taken as an overvoltage isolation protection device for the buck converter. Because an excessive current will be induced when the transistor switch 102 is short-circuited failure and SCR is triggered on by overvoltage detecting circuit 106, the fuse 109 will be blown out to isolate the input voltage Vᵢₙ, thereby cutting off the energy of the buck converter.

Nevertheless, for the conventional buck converter, the art of using a SCR controlled by a voltage sensing device and a fuse as an overvoltage isolation protection device for the buck converter to protect the buck converter from outputting an excessive voltage due to an short-circuited voltage switch of the buck converter, is not an ideal solution, and some drawbacks are stilled existed. Above all, the fuse 109 can not be blown out on the instant that the buck converter is detected to output an excess voltage to trigger on SCR, but to take a span of time for the fuse to blow out. Hence, in consideration of the efficiency of cutting off the energy of the buck converter, using a fuse to prevent the buck converter from outputting an excessive voltage is not able to forthwith prevent the buck converter from the damage arising form an excessive output voltage. Further, after the fuse is blown out, the fuse must be replaced with a new one and the buck converter can restart to operate. In practical applications, the way of using fuse to protect the buck converter from getting damaged on account of a short-circuited voltage switch of the buck converter is not a flawless technique.

There is an inclination to provide an overvoltage protection device for use with the buck converter, which comprises a transistor switch coupled in series between an input voltage and a voltage switch of the buck converter and serves as an overvoltage protection circuit to protect the buck converter from outputting an excessive voltage when the voltage switch is short-circuited, and further comprises a voltage detecting circuit coupled to a voltage output terminal of the buck converter which compares the output voltage of the buck converter with a predetermined voltage level and in response thereto, outputs a control signal, and drives the PWM controller of the buck converter and the overvoltage protection circuit to turn off in response to the control signal.

### SUMMARY OF THE INVENTION

An object of the present invention is to provide an overvoltage protection device for use with a buck converter, which can be biased to isolate the buck converter from an input voltage when the buck converter outputs a voltage beyond a predetermined voltage level on account of a short-circuited voltage switch of the buck converter.

A further object of the present invention is to provide a voltage regulator which can automatically detect if its output voltage exceeds a predetermined voltage level, and outputs a control signal to drive a transistor switch to cut off the energy of the voltage regulator when its output voltage substantially exceeds the predetermined voltage level.

Another further object of the present invention is to provide a buck converter with an overvoltage protection device, in which the overvoltage protection device is capable of automatically and immediately cutting off the energy of the buck converter when the buck converter outputs an excessive output voltage caused by a short-circuited voltage switch of the buck converter.

According to an exemplary embodiment of the present invention, an overvoltage protection device is provided to be coupled in series between an input voltage and a buck converter for isolating the input voltage from the buck converter when an output voltage of the buck converter exceeds a predetermined voltage level due to a short-circuited voltage switch of the buck converter. The overvoltage protection device of the present invention comprises a voltage detecting circuit for detecting if the output voltage of the buck converter exceeds the predetermined voltage level and in response thereto, outputs a control signal, and a transistor switch (preferably, the transistor switch is comprised of a N-channel MOSFET) coupled in series between the input voltage and a voltage switch of the buck converter, wherein the transistor switch is driven by the control signal to turn on and off, for isolating the buck converter from the input voltage when the output voltage of the buck converter exceeds the predetermined voltage level on account of a short circuit appeared on the voltage switch of the buck converter.

In accordance with a conceptual practice of the present invention, the voltage detecting circuit includes a comparator which compares the output voltage of the buck converter with a reference voltage and in response thereto, outputs a voltage level signal, and a latch circuit for memorizing the voltage level signal to provide a memorized voltage level and outputs the control signal according to the memorized voltage level.

According to a second aspect of the present invention, a voltage converter for converting an input voltage into a lower output voltage comprises an output filter for providing the output voltage to a load, a voltage switch coupled in series between the input voltage and the output filter, a controller which compares the output voltage with a first reference voltage and in response thereto, outputs a switch control signal to turn the voltage switch on and off to generate the output voltage, and an overvoltage protection device coupled in series between the output voltage and the input voltage for detecting if the output voltage exceeds a predetermined voltage level, and isolating the voltage switch from the input voltage when the output voltage exceeds the predetermined voltage level on account of a short circuit appeared on the voltage switch.

The output filter is constructed formed from an inductor and a capacitor, and the voltage switch is preferably directed to a N-channel MOSFET.

The foregoing overvoltage protection device is composed of a voltage detecting circuit for detecting if the output voltage exceeds the predetermined voltage level and in response thereto, outputs a control signal, and a transistor switch which is also preferably directed to a N-channel MOSFET and is driven by the control signal to turn on and off, for isolating the voltage switch and the input voltage as the output voltage exceeds the predetermined voltage level on account of the short circuit appeared on the voltage switch.

The overvoltage detecting circuit further includes a comparator which compares the output voltage with a second reference voltage and in response thereto, outputs a voltage level signal, and a latch circuit for memorizing the voltage level signal to provide a memorized voltage level and outputs the control signal to drive the transistor switch to turn on and off according to the memorized voltage level.

The voltage converter of the present invention further comprises a feedback circuit for feeding the output voltage from an voltage output terminal back to a voltage input pin of the controller, and a startup circuit for providing a DC voltage to initialize the controller through a startup resistor.

In the light of a third respect of the present invention, a voltage regulator with an overvoltage protection device to cope with the excessive output voltage is provided to convert a input DC voltage to a lower output DC voltage, and includes an output filter for providing an output voltage to a load, a first voltage switch which is preferably composed of a N-channel MOSFET for being coupled in series between the input voltage and the output filter, a second voltage switch which is preferably composed of a diode for being coupled in series between the first voltage switch and a ground terminal, a controller which compares the output voltage with a first reference voltage and in response thereto, outputs a switch control signal to turn the first voltage switch and the second voltage switch on and off and generates the output voltage, and an overvoltage protection device coupled in series between the output voltage and the input voltage for detecting if the output voltage exceeds a predetermined voltage level, and isolating the first voltage switch from the input voltage when the output voltage exceeds the predetermined voltage level on account of a short circuit appeared on the first voltage switch.

According to the present invention, the above-described output filter is made up of an inductor and a capacitor, and the overvoltage protection device includes a voltage detecting circuit for detecting if the output voltage exceeds the predetermined voltage level and in response thereto, outputs a control signal, and a transistor switch which is also preferably implemented by a N-channel MOSFET and is driven by the control signal to turn on and off, for isolating the first voltage switch and the input voltage as the output voltage exceeds the predetermined voltage level on account of the short circuit appeared on the first voltage switch.

The aforesaid voltage detecting circuit further comprises a comparator which compares the output voltage with a second reference voltage and in response thereto, outputs a voltage level signal, and a latch circuit for memorizing the voltage level signal to provide a memorized voltage level and outputs the control signal to drive the transistor switch to turn on and off according to the memorized voltage level.

In accordance with the voltage regulator according to the present invention, the voltage regulator further encompasses a feedback circuit for feeding the output voltage from an voltage output terminal back to a voltage input pin of the controller, and a startup circuit for providing a DC voltage to initialize the controller through a startup resistor.

Now the foregoing and other features and advantages of the present invention will be more clearly understood through the following descriptions with reference to the accompanying drawings, in which:

### BRIEF DESCRIPTION OF THE DRAWINGS

FIG. 1 schematically depicts a circuit block diagram of the buck converter and the overvoltage protection device thereof for use in a switching mode power supply according to the prior art; and

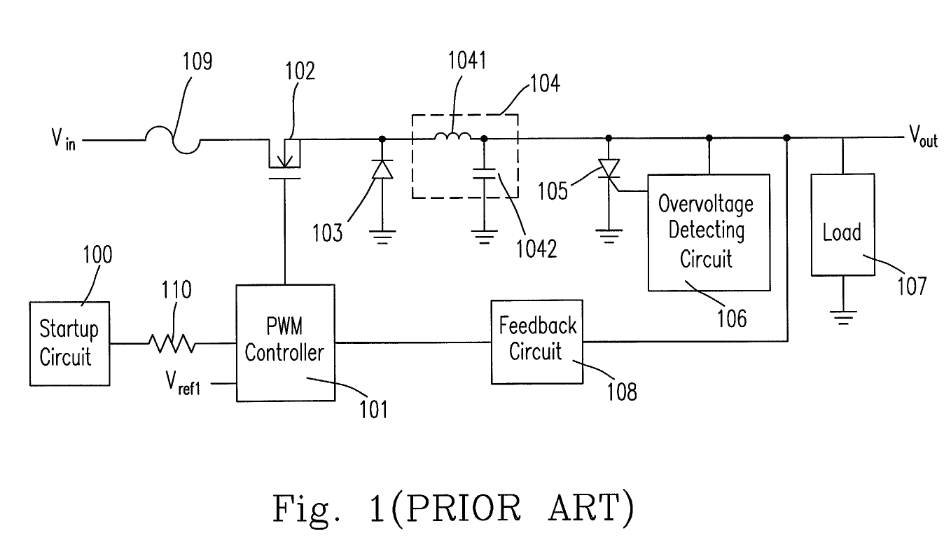

FIG. 2 is a plane view showing the buck converter and the overvoltage protection device thereof for use in a switching mode power supply according to the present invention.

### DETAILED DESCRIPTION OF THE PREFERRED EMBODIMENT

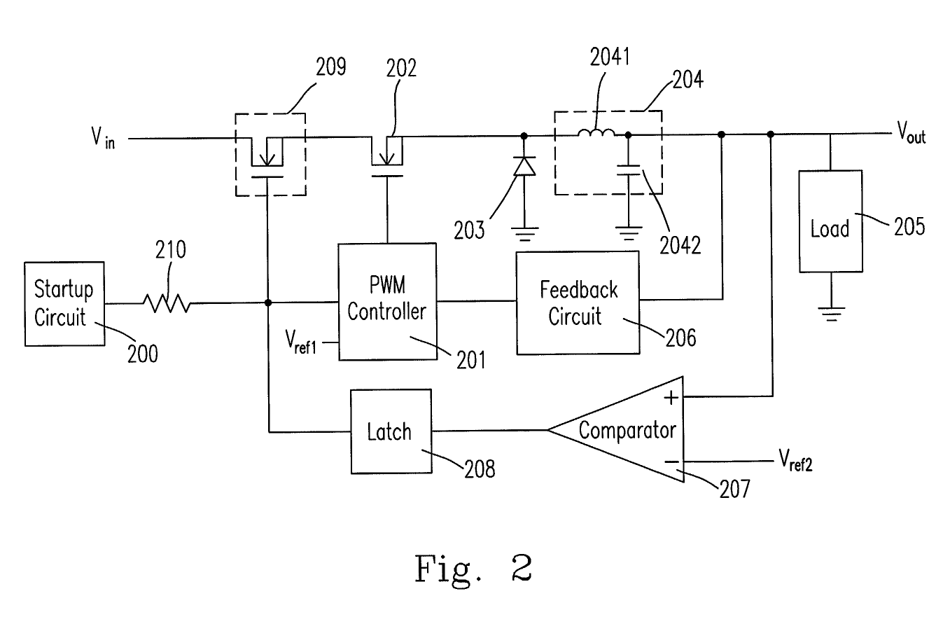

An exemplary embodiment of the present invention now will be fully described with reference to the circuit block diagram of FIG. 2. It is to be emphasized that the following descriptions of embodiments and examples of the present invention is only illustrative, and it is not intended to be exhaustive or not to be limited to the precise form disclosed.

Referring now to FIG. 2, the buck converter according to the present invention is used to convert an input direct current (DC) voltage Vᵢₙ to a lower output DC voltage Vₒᵤₜ. According to an exemplary embodiment of the present invention, the buck converter includes a voltage switch 202 which is coupled in series between the input voltage Vᵢₙ and an output filter 204. The output filter 204 is comprised of an inductor 2041 and a capacitor 2042, and is capable of providing a DC output voltage Vₒᵤₜ to a load 205. Moreover, the DC output voltage Vₒᵤₜ is fed back to a voltage input pin of the PWM controller 201 through a feedback circuit 206. The PWM controller 201 compares the output voltage Vₒᵤₜ with a first reference voltage V_{ref1} and in response thereto, outputs a switch control signal to drive the voltage switch 202. The PWM controller 201 substantially acts as a power supply control circuit for the buck converter, and it is embodied in a 3843 or 3844 series integrated circuit chip. For the sake of normally initializing the control function of the PWM controller 201, a startup circuit 200 is indispensable to the PWM controller 201 for providing a required startup DC voltage and current to the PWM controller 201. The startup DC voltage and current are transmitted from the startup circuit 200 to the PWM controller 201 through a startup resistor 210 with the purpose of initializing the control function of the PWM controller 201.

The voltage switch 202 preferably comprises a N-channel MOSFET (NMOS), and it can be controlled to selectively couple the input voltage Vᵢₙ to the output filter 204 to generate an output DC voltage Vₒᵤₜ. The gate of the voltage switch 202 is connected to the PWM controller 201, and the PWM controller 201 compares the output DC voltage Vₒᵤₜ with a first reference voltage V_{ref1} and in response thereto, outputs a switch control signal to control the voltage switch 202. When the output DC voltage Vₒᵤₜ is lower than the first reference voltage V_{ref1}, the PWM controller 201 will drive the voltage switch 202 to turn on. When the output DC voltage Vₒᵤₜ is higher than the first reference voltage V_{ref1}, the PWM controller 201 will drive the voltage switch 202 to turn off. When the voltage switch 202 turns on, the capacitor 2042 as a part of the output filter 204 will be charged. When the voltage switch 202 turns off, the capacitor 2042 as a part of the output filter 204 will start to discharge to ensure that the output filter 204 can consecutively provide a constant DC output voltage to the load 205. The PWM controller 201 operates to control the on/off state of the voltage switch 202 and the diode switch 203, whereby generating a desired output DC voltage Vₒᵤₜ.

To protect the buck converter from outputting an excessive voltage as the voltage switch of the buck converter is short-circuited to ground and thus brings about some negative influences on the buck converter, an overvoltage protection circuit 209 is placed between the input voltage Vᵢₙ and the voltage switch 202. The overvoltage protection circuit according to a preferred embodiment of the present invention is directed to a transistor switch, which comprises, for example, a N-channel MOSFET (NMOS).

As a part of the overvoltage protection device according to the present invention, a voltage detecting circuit is placed at the voltage output terminal of the buck converter for detecting whether the output voltage Vₒᵤₜ of the buck converter exceeds a predetermined voltage level. The voltage detecting circuit according to the present invention comprises a comparator 207 and a latch circuit 208. The comparator 207 compares the output voltage Vₒᵤₜ with a second reference voltage V_{ref2} to determine if the output voltage Vₒᵤₜ of the buck converter exceeds a predetermined voltage level, whereby detecting if the buck converter comes into a state of excessive output voltage. After the comparator 207 compares the output voltage Vₒᵤₜ with a second reference voltage V_{ref2}, a voltage level signal (such as a binary 0 or a binary 1) is outputted from the output terminal of the comparator 207, and the voltage level signal will be memorized by the latch circuit 208 to provide a memorized voltage level and outputs a control signal to drive the PWM controller 201 and the voltage switch 202.

The latch circuit 208 issues the control signal according to the memorized voltage level to the PWM controller 201 and the overvoltage protection circuit 209. If the output voltage Vₒᵤₜ is excessive, the control signal issued by the latch circuit 206 will change its state. The PWM controller 201 will be shut down in response to the state transition of the control signal issued by the latch circuit 208. The overvoltage protection circuit 209 is driven by the control signal from the latch circuit 208 and stays at the on state during the normal operation of the buck converter. If the buck converter outputs an excessive output voltage, the control signal issued by the latch circuit 208 will change its state and the overvoltage protection circuit 209 will turn off in response to the state transition of the control signal. Once the transistor switch 209 turns off, it behaves likes a conventional fuse for use with the buck converter as an overvoltage protection device, such that the input voltage Vᵢₙ and the voltage switch 202 are separated from each other and the energy of the buck converter will be cut off accordingly. However, the overvoltage protection device according to the present invention does not require a span of time to cut off the energy of the buck converter as the fuse does, but can instantaneously disconnect the voltage switch 202 from the input voltage Vᵢₙ to prevent the voltage switch 202 from receiving the input voltage Vᵢₙ and continuing the voltage conversion operation. After the reason for causing the buck converter to output an excessive output voltage has been excluded, the overvoltage protection circuit 209 will automatically revert to the on state to connect with the input voltage Vᵢₙ, and the buck converter can restart to operate normally.

The buck converter according to a preferred embodiment of the present invention is peculiarized by that an overvoltage protection circuit, for example a transistor switch, is employed to function when the buck converter comes into a state of an excessive output voltage on account of a short-circuited voltage switch of the buck converter. In the light of the operating fundamentals of buck converter according to the present invention, the output voltage of the buck converter will be detected by a voltage detecting circuit to determine whether an excessive voltage is outputted from the buck converter. If the problem of excessive output voltage for a buck converter is occurred due to a short-circuited voltage switch of the buck converter, the voltage detecting circuit as a part of the overvoltage protection device according to the present invention will detect the excessive output voltage and outputs a control signal in response to the excessive output voltage to drive the PWM controller of the buck converter to shut down and drive the transistor switch connected in series between the input voltage and the voltage switch of the buck converter to turn off. Consequently, the energy of the buck converter will be cut off instantaneously so as to protect the buck converter from suffering the risk of excessive output voltage. In one embodiment of the present invention, because a transistor switch is employed in lieu of a fuse to serve as a overvoltage protection circuit for a buck converter, it can rapidly and safely switch the energy state of the buck converter, and more particularly it will not take a span of time to be blown out like a fuse. In addition, while the buck converter of the present invention has returned from the state of excessive output voltage, the transistor switch will automatically turn on without the need to be substituted for a new one. The overvoltage protection device for buck converter including a transistor switch as an overvoltage protection circuit is capable of rapidly and safely protect the circuitry of the buck converter as the buck converter outputs an excessive voltage, and can enable the buck converter to restart operating after the buck converter has been normalized to provide a regular output voltage, such that the drawbacks encountered by the prior art overvoltage protection device for buck converter can be thoroughly settled.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What we claim is:

1. An overvoltage protection device for use with a buck converter, which is coupled between an input voltage and said buck converter for isolating said buck converter from said input voltage, when an output voltage of said buck converter exceeds a predetermined voltage level on account of a short-circuited voltage switch of said buck converter, comprising:
a voltage detecting circuit for detecting if said output voltage of said buck converter exceeds said predetermined voltage level and in response thereto, outputs a control signal; and
a transistor switch coupled in series between said input voltage and a voltage switch of said buck converter, said transistor switch is driven by said control signal to turn on and off in response to said control signal, for isolating said buck converter from said input voltage when said output voltage of said buck converter exceeds said predetermined voltage level on account of a short circuit appeared on said voltage switch of said buck converter.

2. The overvoltage protection device as recited in claim 1 wherein said voltage detecting circuit comprises:
a comparator which compares said output voltage of said buck converter with a reference voltage and in response thereto, outputs a voltage level signal; and
a latch circuit for memorizing said voltage level signal to provide a memorized voltage level and outputs said control signal according to said memorized voltage level.

3. The overvoltage protection device as recited in claim 1 wherein said transistor switch comprises a N-channel metal-oxide-semiconductor field effect transistor.

4. A voltage converter for converting an input voltage to a lower output voltage, comprising:
an output filter for providing said output voltage to a load;
a voltage switch coupled in series between said input voltage and said output filter;
a controller which compares said output voltage with a first reference voltage and in response thereto, outputs a switch control signal to turn said voltage switch on and off to generate said output voltage; and
an overvoltage protection device coupled in series between said output voltage and said input voltage for detecting if said output voltage exceeds a predetermined voltage level, and isolating said voltage switch from said input voltage when said output voltage exceeds a predetermined voltage level.

5. The voltage converter as recited in claim 4 wherein said output filter comprises an inductor and a capacitor.

6. The voltage converter as recited in claim 4 wherein said voltage switch comprises a N-channel metal-oxide-semiconductor field effect transistor.

7. The voltage converter as recited in claim 4 wherein said overvoltage protection device comprises:
a voltage detecting circuit for detecting if said output voltage exceeds said predetermined voltage level and in response thereto, outputs a control signal; and
a transistor switch coupled in series between said input voltage and said voltage switch of said buck converter, said transistor switch is driven by said control signal to turn on and off in response to said control signal, for isolating said voltage switch from said input voltage when said output voltage exceeds said predetermined voltage level.

8. The voltage converter as recited in claim 7 wherein said voltage detecting circuit comprises:
a comparator which compares said output voltage with a second reference voltage and in response thereto, outputs a voltage level signal; and
a latch circuit for memorizing said voltage level signal to provide a memorized voltage level and outputs said control signal according to said memorized voltage level.

9. The voltage converter as recited in claim 7 wherein said transistor switch comprises a N-channel metal-oxide-semiconductor field effect transistor.

10. The voltage converter as recited in claim 4 further comprising a feedback circuit for feeding said output voltage at an voltage output terminal of said output filter back to an input terminal of said controller.

11. The voltage converter as recited in claim 4 further comprising a startup circuit for providing a direct current (DC) voltage to initialize said controller through a startup resistor.

12. A voltage regulator for converting an input direct current (DC) voltage to a lower output direct current (DC) voltage, comprising:
an output filter for providing said output voltage to a load;
a first voltage switch coupled in series between said input voltage and said output filter;
a second voltage switch coupled in series between said first voltage switch and a ground terminal;
a controller which compares said output voltage with a first reference voltage and in response thereto, output a switch control signal to turn said first voltage switch and said second voltage switch on and off to generate said output voltage; and
an overvoltage protection device coupled in series between said output voltage and said input voltage for detecting if said output voltage exceeds a predetermined voltage level, and isolating said first voltage switch from said input voltage when said output voltage exceeds a predetermined voltage level.

13. The voltage regulator as recited in claim 12 wherein said output filter comprises an inductor and a capacitor.

14. The voltage regulator as recited in claim 12 wherein said first voltage switch comprises a N-channel metal-oxide-semiconductor field effect transistor and said second voltage switch comprises a diode.

15. The voltage regulator as recited in claim 12 wherein said overvoltage protection device comprises:
a voltage detecting circuit for detecting if said output voltage exceeds said predetermined voltage level and in response thereto, outputs a control signal; and
a transistor switch coupled in series between said input voltage and said first voltage switch of said buck converter, said transistor switch is driven by said control signal to turn on and off in response to said control signal, for isolating said first voltage switch from said input voltage when said output voltage exceeds said predetermined voltage level.

16. The voltage regulator as recited in claim 15 wherein said voltage detecting circuit comprises:
a comparator which compares said output voltage with a second reference voltage and in response thereto, outputs a voltage level signal; and
a latch circuit for memorizing said voltage level signal to provide a memorized voltage level and outputs said control signal according to said memorized voltage level.

17. The voltage regulator as recited in claim 15 wherein said transistor switch comprises a N-channel metal-oxide-semiconductor field effect transistor.

18. The voltage regulator as recited in claim 12 further comprising a feedback circuit for feeding said output voltage at an voltage output terminal of said output filter back to an input terminal of said controller.

19. The voltage regulator as recited in claim 12 further comprising a startup circuit for providing a direct current (DC) voltage through a startup resistor to initialize said controller.
